(19) United States
(12) Patent Application Publication
(10) Pub. No.: US 2005/0123111 A1
(43) Pub. Date: Jun. 9, 2005

(54) Method and system to process a request for communication between a calling device and a called device

(76) Inventors: Brendan Philbin, San Jose, CA (US); Phil Apanovitch, Glastonbury, CT (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/895,872

(22) Filed: Jul. 20, 2004

Related U.S. Application Data
(60) Provisional application No. 60/489,067, filed on Jul. 21, 2003.

(51) Int. Cl. H04M 15/00

(52) U.S. Cl. 379/114.2; 379/114.01

(57) ABSTRACT

A method and an apparatus is provided to process a request for communication between a calling device and a called device. The method includes receiving the request from the calling device at a communication processor and establishing a communication link between the communication processor and the called device. Thereafter, the called device is provided with a prepayment option to pay funds into a client account and the called device is monitored for selection of the prepayment option. When the prepayment option is selected, the called device is connected to a prepayment facility thereby to enable a prepayment account to be set up immediately without requiring the called party to place an independent call to the prepayment facility.

### CLAIM OF PRIORITY

This application claims the priority of U.S. Provisional Application No. 60/489,067 filed Jul. 21, 2003 which is incorporated herein by reference.

### FIELD OF THE INVENTION

The present invention relates generally to the field of communications and, more specifically, to a method and system to process a request for communication between a calling device and a called device.

### BACKGROUND OF THE INVENTION

Calls often need to be made from a calling device to a called device, e.g. from one telephone to another, where the calling device does not pay for the call. Typically, in these circumstances, a collect call is made from the calling device to the call device. However, in certain circumstances, collect calling may be blocked or a collect call account threshold may be reached and, accordingly, the call from the calling device is thus terminated. For example, collect calls may not be completed to called devices if the local service of the called device is provided by a competitive local exchange carrier (CLEC). Recent studies have shown that approximately eight percent of access lines in the U.S.A. are being served by CLECs and, in certain densely populated regions such as New York or states where local competition is encouraged by state regulatory bodies, this percentage may be as high as twenty five percent. In circumstances where a home telephone number is being serviced by a CLEC, the user of the called device may be faced with a decision of either transferring back to an incumbent local exchange carrier (ILEC) for local service thereby allowing collect calls to complete and appear on their local telephone bill, or not receive collect calls.

### SUMMARY OF THE INVENTION

A method and system to process a request for communication between a calling device and a called device, e.g., two telephones, are provided. The method includes receiving the request from the calling device at a communication processor and establishing a communication link between the communication processor and the called device. The called device is then provided with a prepayment option to pay funds into a client account and the called device is monitored for selection of the prepayment option. The called device is then connected to a prepayment facility when the prepayment option is selected.

In certain embodiments, connecting the called device to the prepayment facility includes establishing a communication link to the prepayment facility without terminating the communication link between the communication processor and the called device. The method may include providing the called device with an option to accept or terminate the request to communicate from the calling device prior to providing the called device with the prepayment option.

The invention extends to a machine-readable medium including instructions that, when executed on a machine, cause the machine to execute any one of the methodologies described herein.

Other features of the present invention will be apparent from the accompanying drawings and from the detailed description which follows.

### BRIEF DESCRIPTION OF THE DRAWINGS

The invention is now described, by way of non-limiting example, with reference to the accompanying diagrammatic drawings in which like reference numerals indicate the same or similar features, unless otherwise indicated.

In the drawings,

FIG. 1 shows a schematic block diagram of a communication system in accordance with one embodiment of the invention;

FIG. 2 shows a schematic flow diagram of a method, in accordance with one embodiment of the invention, for communicating between a calling device and a called device;

FIG. 3 shows a more detailed schematic flow diagram of the method of FIG. 2;

FIG. 4 shows exemplary prepaid collect validation functionality of the method;

FIG. 5 shows dialed number frequency threshold functionality of the method;

FIG. 6 shows a schematic flow diagram of trunk routing and dialing functionality of the method;

FIG. 7 shows a schematic flow diagram of call answering functionality of the method;

FIG. 8 shows a schematic flow diagram of prepaid acceptance functionality of the method;

FIG. 9 shows a schematic flow diagram of collect call acceptance functionality of the method; and

FIG. 10 shows a schematic block diagram of a machine in the exemplary form of a computer system within which a set of instructions, for causing the machine to perform any one of the methodologies discussed herein, may be executed.

### DETAILED DESCRIPTION

Referring to the drawings, reference numeral 10 generally indicates a communication system for processing a request for communication between a calling device 12 (e.g. a telephone) and a called device 14 (e.g. a telephone) via a call processor 16. As described in more detail below, the call processor 16 is operable to connect the called device 14 to a prepayment facility 18 in an automated and seamless fashion without human intervention e.g. by way of a conference bridge. The system 10 further includes an optional line number validation facility 20 and the call processor 16 includes a prepayment module 22 with its associated processing tables 24. The line number validation facility 20 and the prepayment facility 18 may be located remotely from the call processor 16. For the purpose of illustration only, the system 10 is described in a correctional services environment where inmates in a prison use the calling device 12 to communicate with other persons such as family and friends using the called device 14.

The system 10 allows the called party to establish a prepayment account at the call processor 16 via the prepayment facility 18. The call processor 16 may be located at the prison and, in certain embodiments, include conventional telecommunication components used in the correctional services environment.

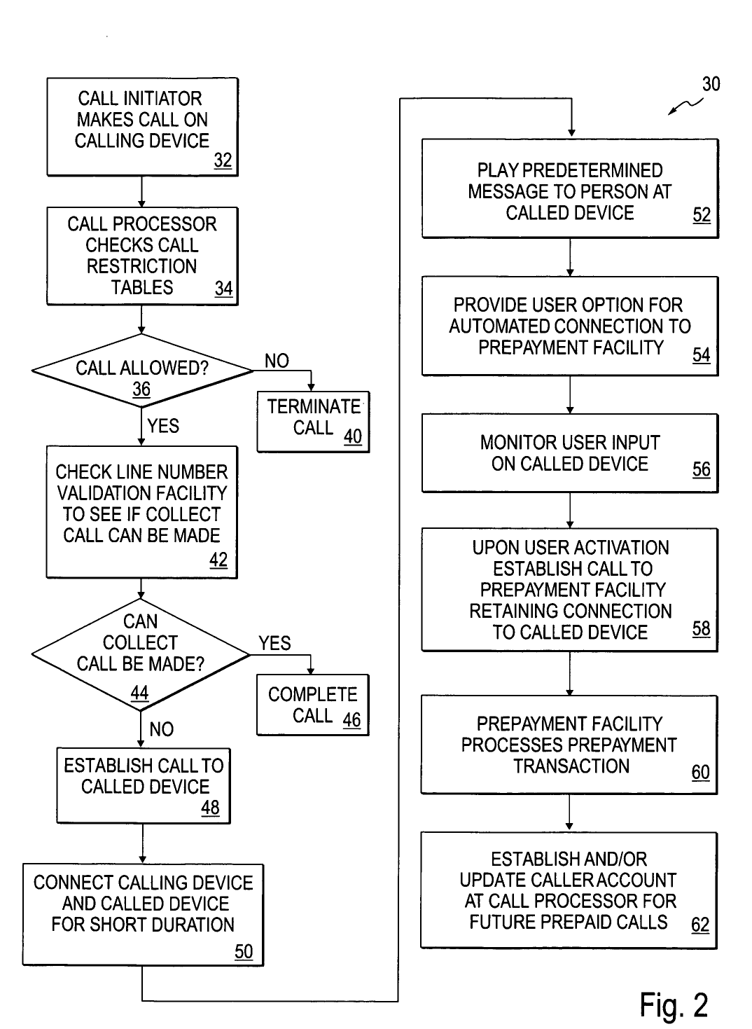

Referring in particular to FIG. 2, reference numeral 30 generally indicates an exemplary method, in accordance with one embodiment of the invention, for processing a request for communication between the calling device 12 and the called device 14. When a call initiator such as a prison inmate, uses the calling device 12 to make a telephone call, he or she dials the desired telephone number as shown at block 32. The call processor 16 may request the inmate to provide identification details such as a personal access number and, in response thereto, the call processor 16 interrogates the processing tables 24 to determine whether or not the inmate is permitted to be placed in communication with the dialed number (see block 34). For example, the inmate may be provided with twenty telephone numbers which he or she is permitted to call such as family members, legal services, or the like. Further, certain telephone numbers may be barred such as, for example, a telephone number of a warden of the prison, a judge, any witnesses in a trial, or the like.

If the inmate is not allowed to make the telephone call (see decision block 36), then the call is terminated as shown at block 40. If, however, the inmate is allowed to make the telephone call to the dialed number, then the call processor 16 checks with the line number validation facility 20 to ascertain whether or not a collect call can made be made to the dialed number (see block 42). As shown at decision block 44, if a collect call can be made, then the call is completed as a collect call as shown at block 46.

If, however, a collect call cannot be made (e.g. the called device 14 is associated with a competitive local exchange carrier (CLEC) or a collect call threshold has been reached) then the call processor 16 establishes a restricted call to the called device 14 (see block 48). The inmate, via the calling device 12, is connected to the called party via the called device 14 (see block 50). In certain embodiments, the calling device 12 and called device 14 are only connected for a short duration (e.g. about one minute) whereafter, as shown at block 52, a pre-determined message is played to the called party via the called device 14. In certain embodiments, the calling device 12 may remain connected during playing of the predetermined message to the called party.

The pre-determined message provides the called party with an option to automatically establish a connection to the prepayment facility 18 (see block 54) thereby to allow the inmate to place a subsequent call in a prepaid fashion. In order to allow the called party to select this prepayment option, the call processor 16 monitors user input on the called device 14, e.g., DTMF tones, as shown at block 56. When a user presses a predetermined number on a keypad of the called device 14, e.g. the number 8, the call processor 16 then establishes a call (e.g. via the communications module 61) to the prepayment facility 18 without dropping the communication link which it has with the called device 14 (see block 58).

The prepayment facility 18 then processes the request from the called party either in a manual or automated fashion and, as described in more detail below, obtains payment information from the called party as shown at block 60. Thereafter, the prepayment facility 18 communicates the payment transaction data to the call processor 16 which then adjust a client account 62 associated with the particular inmate. In certain embodiments, the client account 62 may only be used to make a telephone call to the party establishing the account.

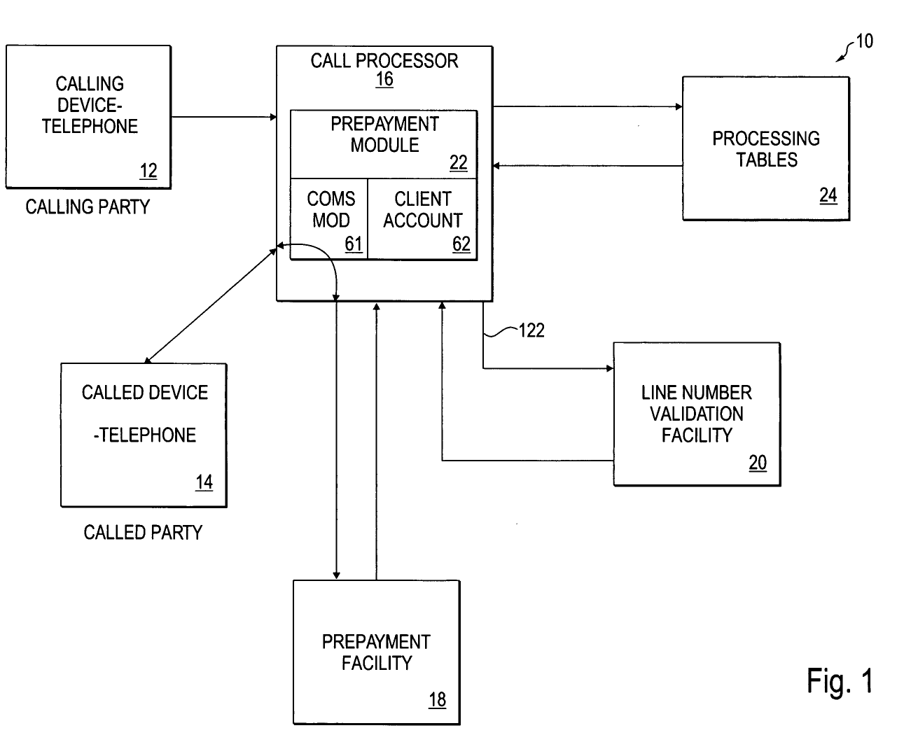

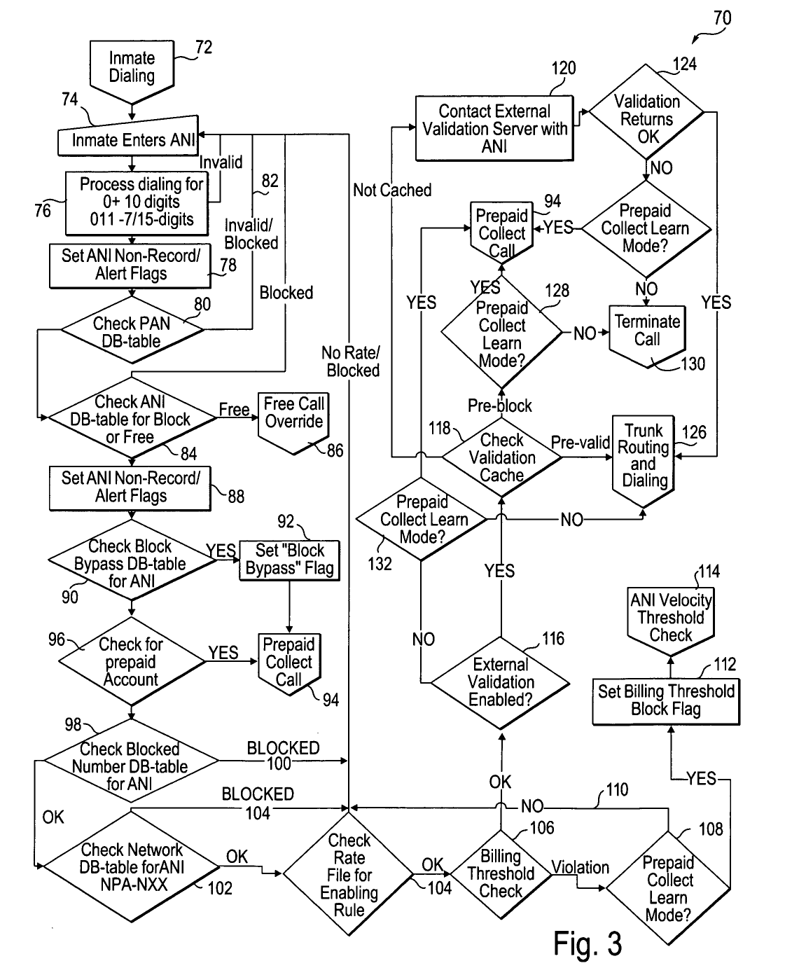

Referring in particular to FIGS. 3-9 of the drawings, reference numeral 70 generally indicates a more detailed schematic flow diagram of an exemplary method 30 of processing a request for communication between the calling device 12 and the called device 14. As shown at 72, when an inmate uses a telephone (which defines the calling device 12), he or she enters the desired telephone number into the telephone as shown at 74 and, thereafter, the communication processor 16 processes the call as shown at 76. If the telephone call is identified as a call that may not be recorded by the call processor 16, e.g. a call to a legal advisor, a non-recording flag is set at block 78. Thereafter, as shown at decision block 80, the inmate may enter his or her personal access number (PAN) which the call processor 16 then verifies using a database table, e.g. the processing tables 24 of FIG. 1. If, the PAN which the inmate has entered is blocked or is invalid, then the method returns to block 74 as shown by line 82, thereby allowing the inmate optionally to enter a further PAN. If, however, the PAN is valid and the call has not been blocked, the method 70 then checks an automatic number identification (ANI) database table to determine whether or not the call is a blocked call or if the call is a free call (see decision block 84.) If the call is a free call e.g. a call to a legal services provider, then an override is generated for a free call as shown at 86. Returning to decision block 84, in certain embodiments, the non-recording flags may be once again set as shown at block 88.

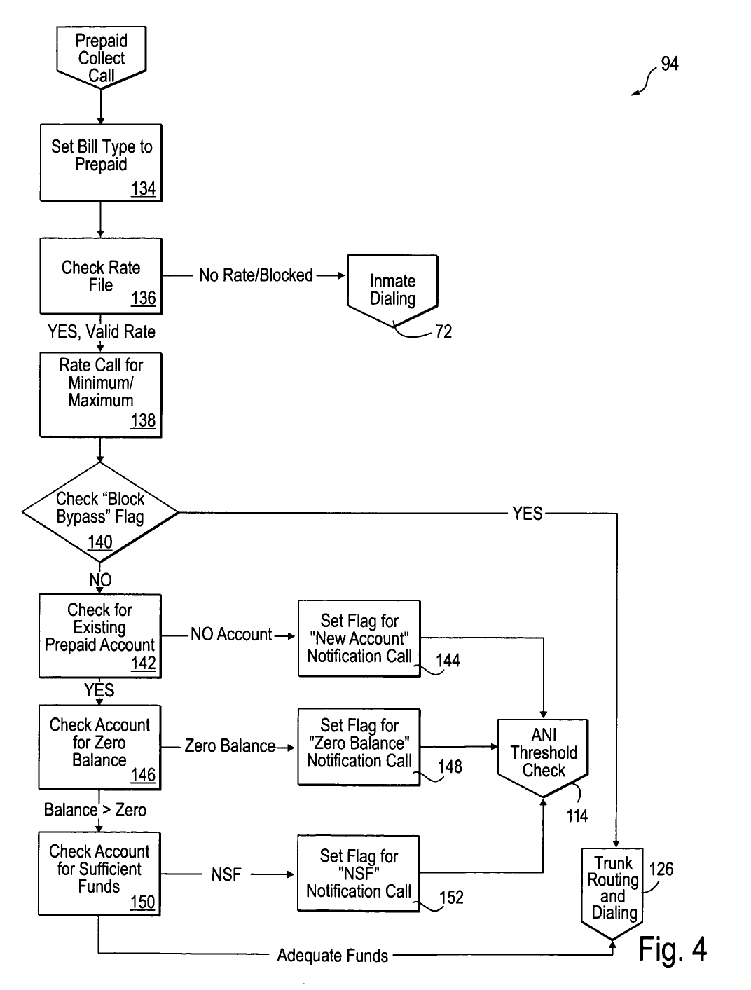

Prior to establishing a telephone connection to the called device 14, the call processor 16 may perform several checks. As shown at block 90, the call processor 16 checks whether or not a block bypass database table for the dialed number exists and, if so, it then sets a “block bypass” flag (see block 92) whereafter the method 70 proceeds to prepaid collect call functionality 94 (see FIG. 4). Returning to decision block 90, if, however, the dialed number is not provided in the block bypass database table, then the call processor 16 checks to determine whether or not a prepaid account for the particular personal access number (PAN) exists (see block 96). If a prepaid account does exist, then the prepaid collect call functionality 94 is executed.

If, however, a prepaid account associated with the PAN does not exist, then as shown at block 98 the call processor 16 checks a blocked number database for the dialed number to determine whether or not the dialed number has been blocked. If the dialed number has been blocked, as shown by line 100 the method 70 returns to block 74 allowing the inmate to optionally enter a further telephone number.

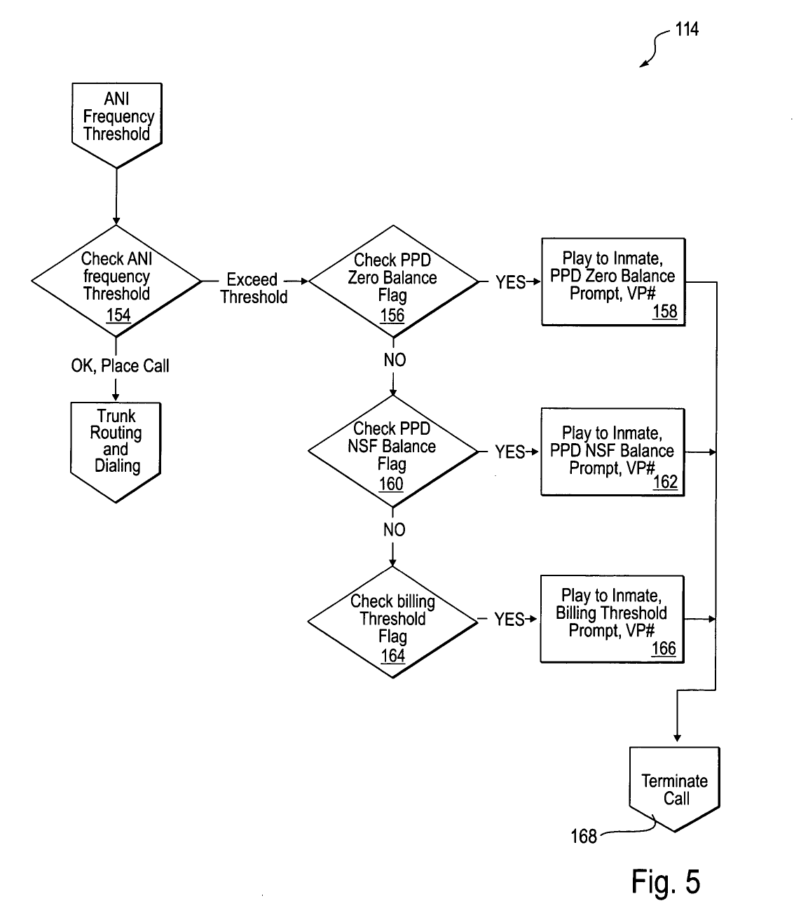

If, however, the ANI or dialed number is not present in the blocked number database table, then the method 70 proceeds to check a network database table to see if the dialed number corresponds with other telephone numbers that may be blocked. If the dialed number has been blocked, as shown by line 104, then the method 70 returns to block 74 where the inmate may optionally enter a further telephone number. If, however, the dialed number or ANI is not in the blocked database table (see block 102), then the call processor 16 checks a rate file for enabling rules at decision block 104. The enabling rules may include a rate charge, whether or not a collect call may be placed, the maximum value of a call that may be placed to avoid exceeding any billing thresholds, and the like. Failure at decision block 104 returns the caller to block 74 thereby providing the inmate with the option of dialing a further number. If, however, the call is not terminated at decision block 104, then the call processor 16 checks a billing threshold (e.g., has a maximum balance been exceeded) as shown at decision block 106. If a billing threshold violation occurs, then the inmate is provided with an option to proceed with the call so that the called party may establish a prepaid call account, as shown at decision block 108. If the establishment of a prepaid collect account is not selected at decision block 108, then the method 70 returns to block 74 as shown by line 110. If, however, the inmate selects to proceed with the call so that the called party may selectively establish a prepaid account, a billing threshold block flag is set at block 112 whereafter a dialed number frequency threshold check 114 is performed (see FIG. 5).

Returning to decision block 106, if the billing threshold has not been reached, then the call processor 16 checks at decision block 116 whether or not validation of the dialed number (ANI), by the line number validation facility 20, has or has not been enabled. If validation by the line number validation facility 20 is required, a validation cache of valid telephone numbers is first checked at decision block 118 and, if the appropriate information is not cached, then the method 70 proceeds to contact the line number validation facility 20 as shown at block 120.

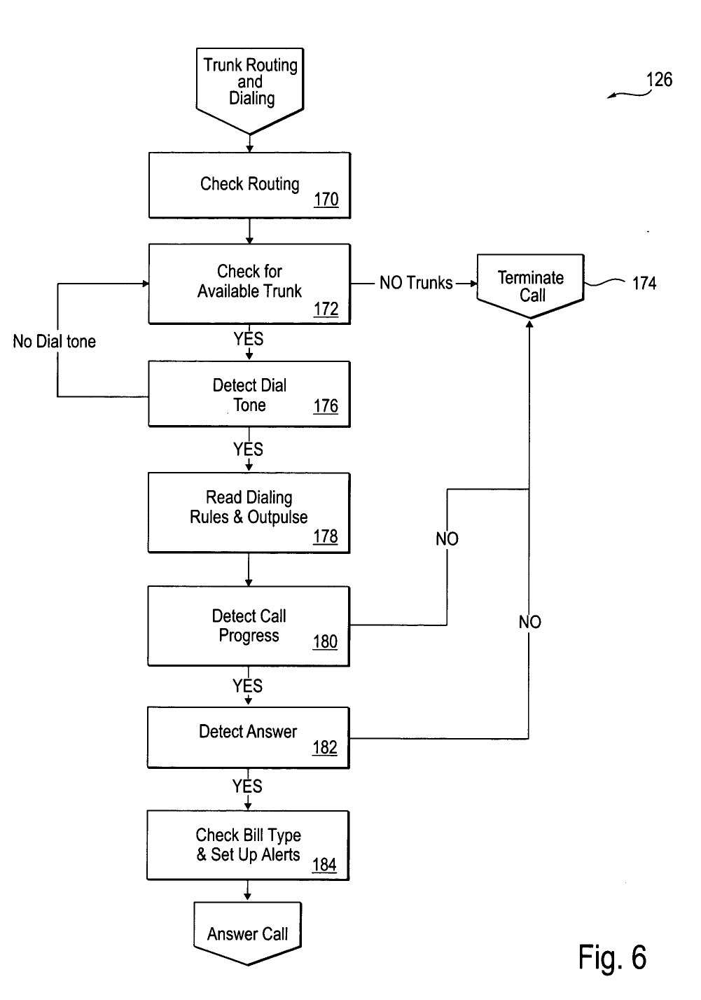

In particular, the ANI or dialed number is provided to the line number validation facility as shown by line 122 in FIG. 1. The validation facility 20 then checks its internal database to determine whether or not the ANI or dialed number is associated with a CLEC and, accordingly, a collect call may thus not be placed. If the line number validation facility 20 returns a positive validation (see decision block 124) then the method 70 proceeds to execute trunk routing and dialing functionality 126 (see FIG. 6). Returning to decision block 118, if a pre-block exists on the ANI, the method 70 proceeds to decision block 128 to determine whether or not the call processor 16 is required to set up a prepaid account. If at decision block 128 the call processor 16 is not required to set up a prepaid account then the call is terminated at block 130. If, however, the call processor 16 is required to set up a prepaid account, then the method proceeds to execute the prepaid collect call functionality 94 of FIG. 4.

Returning to decision block 116, if the external validation of the ANI by the line number validation facility 20 is not enabled, then the method proceeds to decision block 132 and, if a prepaid account is to be set up, then the method 70 proceeds to the prepaid call collect functionality 94. If, however, a prepaid account already exists or is not required to be set up, then the method 70 proceeds to the trunk routing and dialing functionality 126.

Referring in particular to FIG. 4, the call processor 16 when executing the prepaid collect validation functionality 94 sets a bill type to prepaid (see block 134) whereafter it checks a rate file at block 136 to determine whether or not a particular rate has been blocked or if no rate is provided for the particular call and, if so, the method 70 returns to block 74 of FIG. 3. A rate block may be defined by a person creating the prepaid account, e.g. the called party. If, however, there is no rate block and the particular rate for the call can be identified, then the functionality 94 proceeds to determine if there are sufficient funds in the prepaid account to complete the call (see block 138). For example, the functionality 94 may determine a minimum balance required to complete at least one minute of the call as well as determine a maximum balance in the prepaid account to compute a maximum duration of the call. Thereafter, as shown at decision block 140, the prepayment module 22 checks the block bypass flag (see block 92 in FIG. 3) and, if the flag is set, then the functionality 94 proceeds to execute the trunk routing and dialing functionality 126 (see FIG. 6). If, however, the block bypass flag is not set, then the prepayment module 22 checks to ascertain whether or not there is an existing prepaid account at block 142 and, if not, then sets a flag indicating “new account” notification call thereby to ensure that an appropriate voice message or notification is played to the called device 14 upon establishing a connection between the call processor 16 and called device 14 (see block 144). In addition, the prepayment module 22 also executes the ANI frequency threshold check functionality 114.

Returning to block 142, if an existing prepaid account exists, then the account is checked for a zero balance at block 146 and, if a zero balance is identified, a flag for the “zero balance” notification call (see block 148) is set so that an appropriate message is then played to the called party. Returning to block 146, if the balance in the prepaid account exceeds zero, then the prepayment module 22 checks if there are sufficient funds to complete the call as shown at block 150. If there are sufficient or adequate finds, then the trunk routing and dialing functionality 126 is executed. If, however, there are insufficient funds then the flag for a non-sufficient funds “NSF” notification is set for an appropriate notification call as shown at block 152. After the appropriate flags have been set at blocks 144, 148 and 152, the ANI frequency threshold functionality 126 is executed.

Referring in particular to FIG. 5, the ANI frequency threshold functionality 114 monitors to see the number of calls which the inmate makes over a given time period and, if the frequency of the calls exceeds a predetermined value, then the current call is terminated. In particular, as shown at decision block 154, the prepayment module 22 compares the number of calls made by the inmate over a given period with an ANI frequency threshold and, if the threshold is exceeded, then the prepayment module 22 at decision block 156 checks a prepaid zero balance flag (see block 148 in FIG. 6) to identify whether or not the balance of the prepaid account is zero. If the balance of the prepaid account is zero, then at block 158 an appropriate prepaid zero balance prompt is communicated to the calling device 12 so that the inmate may be appropriately informed.

If, however, the prepaid balance flag is not set, then the prepayment module 22 checks the prepaid NSF balance flag (see block 152 in FIG. 4) to identify whether or not there are sufficient funds in the prepaid client account 62 to complete the call (see decision block 160). If the prepaid NSF balance flag is set (e.g. there are insufficient funds in the prepaid client account 62) then an appropriate message is played to the inmate at 162 to indicate that there are insufficient funds remaining in the prepaid account.

If, however, the prepaid NSF balance flag is not set, then the prepayment module 22 at decision block 164 checks to determine whether or not a billing threshold flag has been set (see block 112 in FIG. 3) and, if so, then a further appropriate message at block 166 may be played to the inmate. Following the playing of the messages in blocks 158, 162 and 160, the call is terminated as shown at 168.

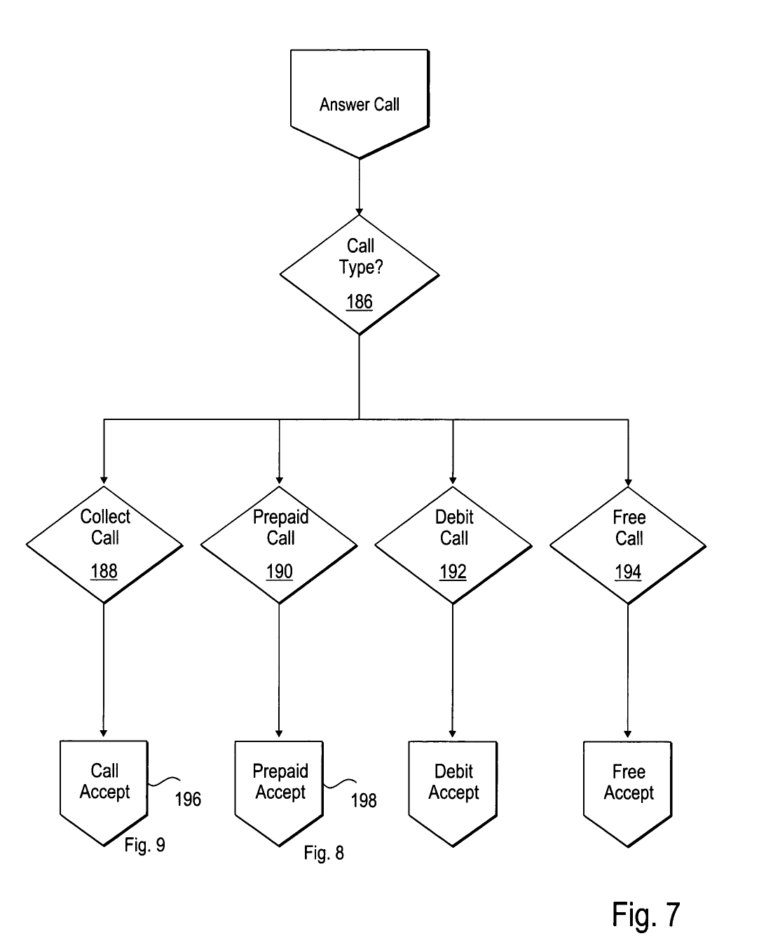

When the prepayment module 22 executes the trunk routing and dialing functionality 126, it first checks the routing at block 170 and thereafter at block 172 checks for an available trunk for establishing the communication link to the called device 14. If no trunk is available, then the call is terminated as shown at 174. If, however, a trunk is available for establishing a call, then the call processor 16 detects whether or not a dial tone is present at block 176 and, if no dial tone is present, the functionality 126 reverts to block 172. If, however, a dial tone is detected, then the call processor 16 may read dialing rules and an output pulse as shown at block 178 and thereafter detect or monitor call progress at 180. If the called device 14 cannot be reached, the call is terminated at 174. If, however, the call processor 16 detects that the call has been answered (see block 182) then the bill type is checked and any set-up alerts that may be required are implemented as shown at block 184. Thereafter, the call functionality is executed as described below with reference to FIG. 7.

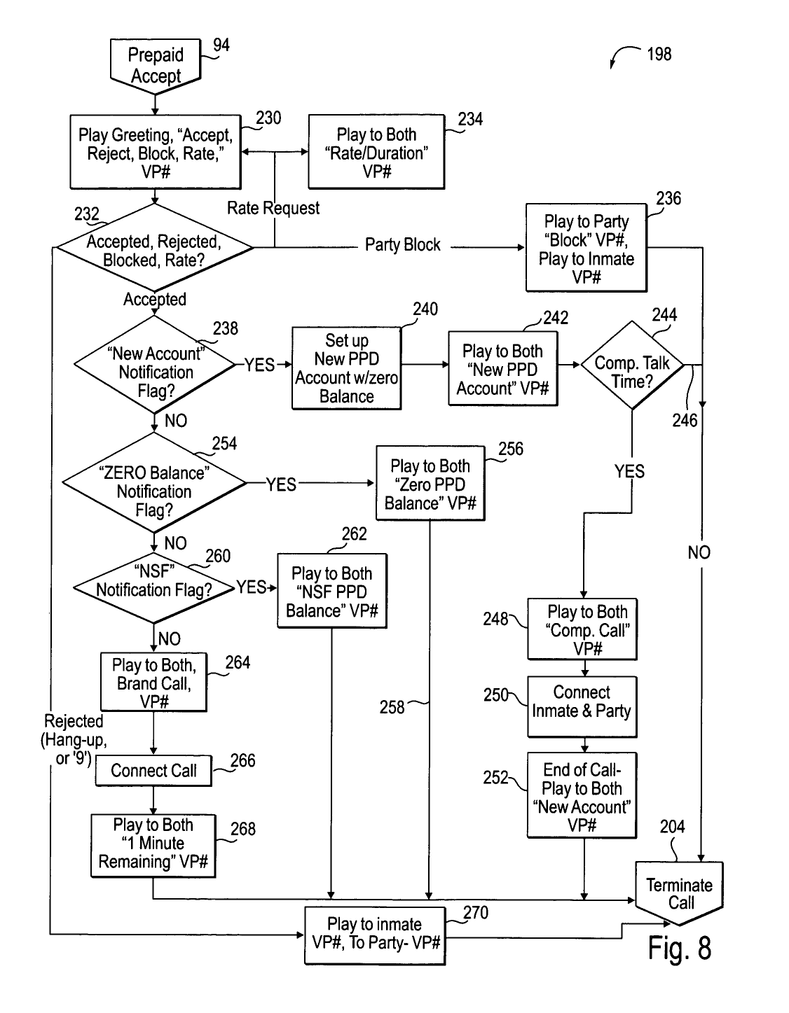

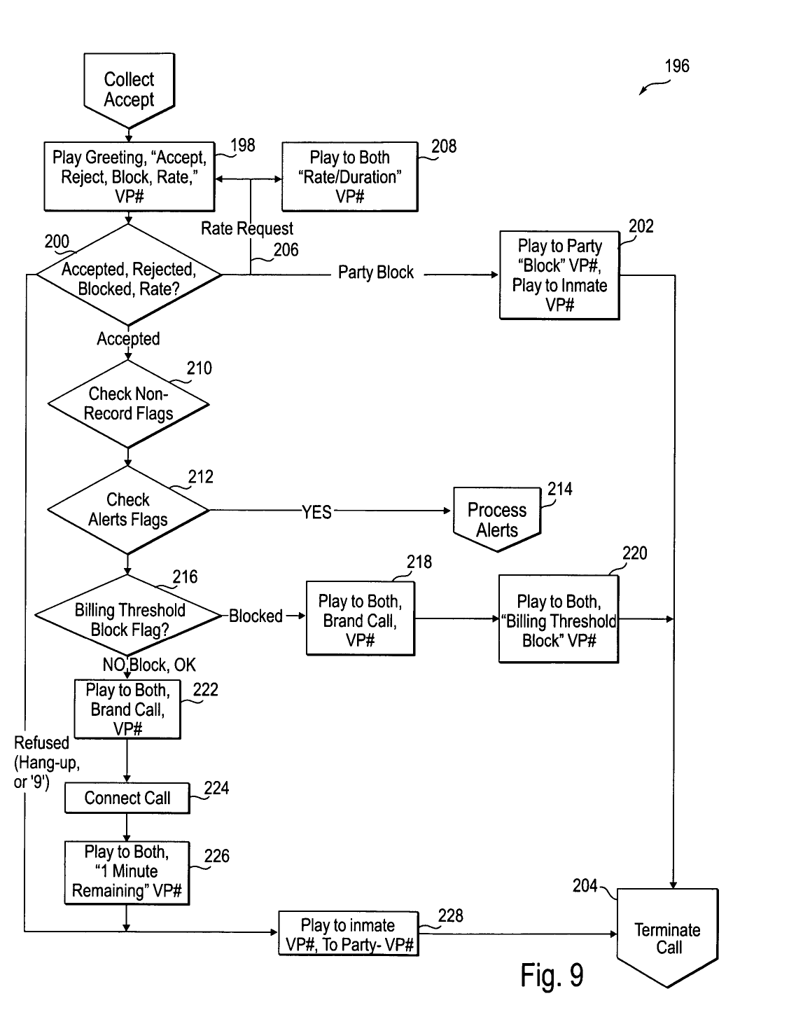

As shown in FIG. 7, at decision block 186, the call processor 22 identifies whether the call is a collect call (see block 188), a prepaid call (see block 190), a debit call (see block 192) or a free call (see block 194). If the call is a collect call, then the collect accept functionality 196 (see also FIG. 9) is executed, if the call is a prepaid call, then the prepaid accept functionality 198 (see also FIG. 8) is executed, if the call is a debit call then conventional debit calling functionality (not shown) may be executed, or if the call is a free call then conventional free accept call functionality may be implemented.

Referring in particular to FIG. 9, when the call processor 16 performs the collect accept functionality 196, a greeting is played to the called party via his or her called device 14 as shown at block 198. Typically, the greeting is followed by an option to accept or reject the call, an option to block the call, an option to identify a rate associated with the call, or the like. The message played to the called party indicates which particular digits on his or her called device 14 should be pressed or activated to identify a particular response. As mentioned above, typically the call processor 16 uses DTMF tones to identify which particular option has been selected by the called party thus, at decision block 200, the call processor 16 identifies which particular option has been selected by the called party.

If the called party selects a party block at decision block 200, then the call processor 16 plays an appropriate blocked message to the inmate and an appropriate blocked message to the called party as shown at block 202, whereafter the call is terminated at 204. If, however, the called party selects a rate request, then as shown by line 206 the call processor 16 plays an appropriate message indicating the rate per duration to the inmate and called party as shown at block 208.

Returning to decision block 200, if the called party accepts the call then, as shown at block 210, the call processor 16 identifies if the non-record flag has been set (see blocks 78 and 88 of FIG. 3) and, thereafter, checks for any alert flags as shown at 212. If the alert flags are set or the non-record flag has been set, then user defined process alerts may be preformed as shown at 214. If, however, the non-record flag or alert flags are not set, then the call processor 16 checks the billing threshold block flag (see block 112 in FIG. 3) as shown at block 216. If a billing threshold flag has been set, then an appropriate message (see above) regarding a branded call is played to both the inmate and the called party at 218 followed by a billing threshold block message at block 220. Thereafter, the call may be terminated at 204.

Returning to block 216, if there is no billing threshold block, then a branded call maybe played to both the called party as well as the inmate as shown at block 222 whereafter the inmate and called party are connected to allow communication between them as shown at 224. Typically, the communication between the inmate and the called party is allowed to exist for about a minute and, accordingly as shown at block 226 an appropriate message may then be played. If the called party at block 200 refuses to accept the call or hangs up, as well as after the message is played to the inmate and called party at 226 further appropriate messages at 228 may be played whereafter call is terminated at 204.

As shown at block 94 in FIGS. 3 and 7, a called party at the called device 14 may use a keypad of the called device 14 to accept the call and to be automatically connected to the prepayment facility 18 so that funds may be transferred to the client account 62 thereby to enable the inmate associated with the client account 62 to make a prepaid telephone call.

Referring in particular to FIG. 8, the prepaid accept functionality 198 is shown in more detail. As shown at block 230 the processor 16 first plays an appropriate greeting to the called party and then plays an accept, reject, block, rate, or the like so that the called party may select the appropriate option using a keypad of the called device 14 (see also block 198 of FIG. 9).

In certain embodiments once the prepaid client account 62 has been established and the Prepaid Service Provider platform has notified the call processor 16 of the payment amount, prepaid collect calls can be completed to the number. An exemplary voice greeting may be as follows:
“Hello, this is a prepaid collect call from [inmate name] at the [facility name] your current account balance is [amount]. To accept this call, dial ‘3’. To refuse this call, dial ‘9’, or hang-up now. For a rate quote on this call, dial ‘4’. To block your number from further calls from this facility, dial ‘7’.”

As in case of block 200 of FIG. 9, at block 232 of FIG. 8 the called party either accepts, rejects, blocks or asks for a rate and, if a rate is requested, an appropriate voice prompt is played to both the inmate and called party as shown at blocks 234 and 230. If the called party blocks the call, then, as shown at block 236 a similar voice prompt to that played at block 202 of FIG. 9 may be provided to the called party and the inmate, whereafter the call terminates at block 204. If, however, the called party accepts the call, then the new account notification flag is checked at block 238 and, if the flag is set thereby indicating a new account is required, the processor 16 then sets up the new account with a zero balance as shown at block 240. Thereafter, an appropriate prepaid account message is played to both the inmate and the called party as shown at block 242 whereafter, as shown at decision block 244 if a complimentary talk feature is not enabled, then the call is terminated, as shown by line 246 and block 204. If, however, complimentary talk feature is enabled, then an appropriate message may be played to both the inmate and the caller at block 248 whereafter the inmate and the called party are connected at block 250. Once the call has ended, then, as shown at block 252, an appropriate message or voice prompt is played to the inmate and the called party whereafter the call terminates as shown at block 204.

Returning to block 238, if the new account notification flag (see block 144 in FIG. 4) is not set, then as shown at block 254, the call processor 16 checks the zero balance notification flag is set (see block 148 in FIG. 4). If the zero balance notification flag is set, then as shown at block 256, an appropriate message or voice prompt may be played to both the inmate and the called party to indicate that the balance in the client account 62 is zero and, accordingly, the call cannot be completed (see exemplary message above). After the message has been played at block 256, the call processor 16 terminates the call 204 as shown by line 258. If, however, the zero balance notification flag is not set, then the call processor 16 checks to determine whether or not the NSF notification flag is set at block 260 (see also block 152 of FIG. 4). If the NSF notification flag is set, then the call processor 16 may play an appropriate message to both the inmate and the called party at block 262 to provide them with the current balance of the client account 62.

Returning to block 260, if the NSF notification flag is not set, then advertising material or the like e.g. details of a particular brand, are played to both the inmate and the called party as shown at block 264. Thereafter, as shown at block 266 the call from the inmate to the called party is connected. When there are only sufficient funds remaining for one minute of connection time, then as shown at block 268, an appropriate one minute remaining voice prompt or message is played to the inmate and called party whereafter the call terminates at 204.

If, however, the called party rejects the call by entering an appropriate digit on his or her telephone, then as shown at block 270 the call is immediately terminated. In certain embodiments of the invention, the funds in the prepayment account 62 may only be used to call the called party who set up the prepaid account 62. Thus, a separate prepaid account may be set up for a number of different authorized telephone numbers that the inmate may call. Each time a call is made to a particular telephone number, the prepaid account 62 associated with the particular called party may then be debited.

In certain embodiments, the called party or party establishing the prepaid account 62 may terminate the account and obtain a refund of any remaining balance in the prepaid account 62. The call processor 16 may also track account balances to identify accounts that have been dormant for any predetermined time period. In these circumstances the refund process may be triggered.

In certain embodiments, following the delivery of a new account notification to the called party and the termination of the call, a prepaid client account 62 may be established at the call processor 16 with a $0.00 balance. The next time the inmate attempts to call a number associated with the account, he or she may receive the following exemplary voice prompt:
“The number you have dialed cannot be called until your party makes payment arrangements with Prepaid Service Provider at 888-123-4567. Please allow sufficient time for the called party to deposit funds”

In one embodiment the above voice prompt will only be played if the inmate initiates a call associated with a $0.00 balance account within a predetermined number of minutes of the previous accepted call to that same number.

If a call is made that is associated with a $0.00 balance account after the predetermined number of minutes has lapsed, the call may then be completed to the called party. After the called party answers and accepts the collect call, e.g., by dialing ‘3’ on their keypad, the call processor 16 may notify the called party that collect calls cannot be completed to this number and that an account relationship must be established with the Prepaid Service Provider. An exemplary voice prompt may be as follows:
“We are sorry, but payment arrangements must be made with Prepaid Service provider before you can receive collect calls from this facility. Please contact Prepaid Service Provider at 888-123-4567 as soon as possible. To repeat this information, press ‘0’.”

A further exemplary voice prompt may be as follows:
“Stay on the line and press ‘8’ to be connected to a Prepaid Service Provider”.

The inmate may be disconnected after the called party presses ‘8’ on their keypad. An option to repeat the information may be provided as follows:
“To repeat this information, press ‘0’.”

The inmate may be disconnected after the first playing of this prompt, however the prompt may be available to the called party until the call processor 16 detects hang-up or silence for 10 seconds.

In certain embodiments, once the funds in the prepaid client account 62 have been exhausted, and after the called party answers and accepts the call, e.g. by dialing ‘3’ on their keypad, the call processor 16 may deliver the following notification to the called party:
“We are sorry, but your prepaid account balance is not sufficient to allow collect calling from this facility. Please contact Prepaid Service Provider at 888-123-4567 at your earliest convenience. To repeat this information, press ‘0’.”

A further exemplary voice prompt may be as follow:
“Stay on the line and press ‘8’ to be connected to a Prepaid Service Provider.”

The inmate may be disconnected after the called party presses ‘8’ on their keypad. An option may be provided to repeat the information by pressing ‘0’ on the called device 14.

The inmate may be disconnected after the first playing of the above prompt, however, the prompt may be available to the called party until the call processor 16 detects hang-up or silence for 10 seconds.

If the call is initiated to an NSF balance account within a predetermined number of minutes of the previous call to the same number, the inmate may hear the following prompt:
“The number you have dialed cannot be called until your party deposits additional funds with Prepaid Service Provider at 888-123-4567. Please allow sufficient time for the called party to deposit funds”

If the call is initiated to an NSF balance account after the predetermined number of minutes has lapsed, the call may be completed to the called party. After the called party answers and accepts the collect call by dialing ‘3’ on their keypad, the call processor 16 may deliver the following notification to the called party:
“We are sorry, but your prepaid account balance is not sufficient to allow collect calling from this facility. Please contact Prepaid Service Provider at 888-123-4567 at your earliest convenience. To repeat this information, press ‘0’.”

The prompt may also include the following:
“Stay on the line and press ‘8’ to be connected to a Prepaid Service Provider.”

The inmate will be disconnected after the called party presses ‘8’ on their keypad. An option may be provided to repeat the information.

The inmate can be disconnected after the first playing of the above prompt, however, the prompt may be available to the called party until the call processor 16 detects hang-up or silence for 10 seconds.

In certain embodiments, once a collect calling account has reached its credit limit or threshold, rather than blocking the call, the call processor 16 may deliver the voice notification set out below to the called party. After the called party answers and accepts the collect call by dialing ‘3’ on their keypad, the call processor 16 may notify the called party that they have reached their credit limit and must establish an account arrangement with Prepaid Service Provider.
“We are sorry, but your number has exceeded its credit limit for collect calling from this facility. Please contact a Prepaid Service Provider at 888-123-4567 at your earliest convenience for payment arrangements. To repeat this information, press ‘0’.”

The voice notification may include the following prompt:
“Stay on the line and press ‘8’ to be connected to a Prepaid Service Provider.”

The inmate may be disconnected after the called party presses ‘8’ on their keypad and be provided with an option to repeat the information.

The inmate may be disconnected after the first playing of this prompt, however the prompt may be available to the called party until the system detects hang-up or silence for 10 seconds.

If a call is initiated to a billing threshold account within a predetermined number of minutes of the previous call to the same number, the inmate may hear the following prompt:
“The number you have dialed has exceeded its credit limit on collect calls and cannot be called until your party makes prior payment arrangements. Your party should establish a prepaid account with a Prepaid Service Provider at 888-123-4567 to allow collect calling. Please allow sufficient time for the called party to deposit funds”

If the call is initiated to the billing threshold account after the predetermined number of minutes has lapsed, the call may be completed to the called party. After the called party answers and accepts the collect call, e.g., by dialing ‘3’ on their keypad, the call processor 16 may deliver the following notification to the called party:
“We are sorry, but your number has exceeded its credit limit for collect calling from this facility. Please contact a Prepaid Service Provider at 888-123-4567 at your earliest convenience for payment arrangements. To repeat this information, press ‘0’.

The following voice prompt may be included:
“Stay on the line and press ‘8’ to be connected to a Prepaid Service Provider.”

The inmate may be disconnected after the called party presses ‘8’ on their keypad and be provided with an option to repeat the information.

The inmate may be disconnected after the first playing of this prompt, however, the prompt may be available to the called party until the call processor 16 detects hang-up or silence for 10 seconds.

In certain embodiments, new account (e.g. called party) is identified as prepaid based upon a response code from the line number validation facility 20. After the called party answers and accepts the collect call by dialing ‘3’ on their keypad, the call processor 16 may notify the called party that collect calls cannot be completed to this number and that an account relationship must be established with a Prepaid Service Provider. For example the following voice message may be played:
“We are sorry, but due to billing issues, your telephone number cannot receive collect calls from this facility [the facility name may be played after the party originally answered] without prior arrangements with the telephone service provider. Please contact a Prepaid Service Provider at 888-123-4567 at your earliest convenience. To repeat this information, press ‘0’.”

The message may include the following prompt:
“Stay on the line for a short one-time complimentary connection with your caller.” or
“Stay on the line and press ‘8’ to be connected to a Prepaid Service Provider.”

The inmate may be disconnected after the called party presses ‘8’ on their keypad.

At the end of the complimentary talk time the following may be played:
“Your time for this complimentary call is over. Please remember that your telephone number cannot receive collect calls from this facility without making prior arrangements with the Prepaid Service Provider. Please call Prepaid Service Provider at 888-123-4567 at your earliest convenience. To repeat this information, press ‘0’.”

The voice prompt may include the following:
“Stay on the line and press ‘8’ to be connected to a Prepaid Service Provider.”

The inmate may be disconnected after the called party presses ‘8’ on their keypad and be provided with an option to repeat the information.

The inmate may be disconnected after the first playing of the prompt, however, the prompt is available to the called party until the call processor 16 detects hang-up or silence for 10 seconds.

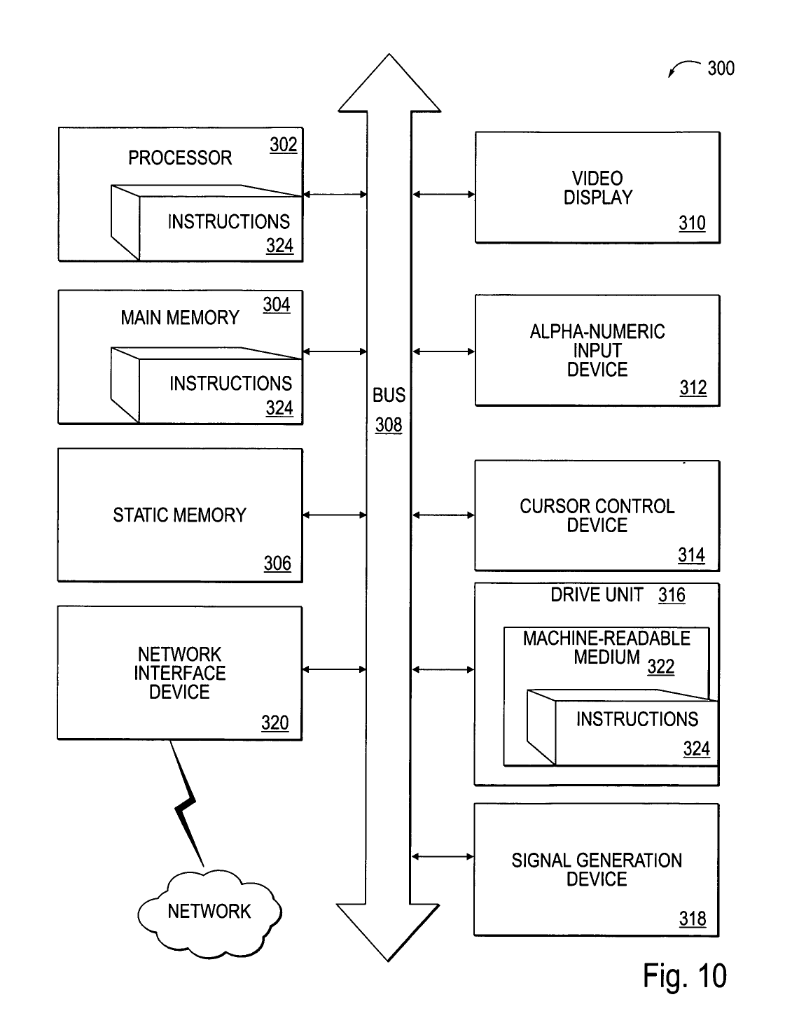

FIG. 10 shows a diagrammatic representation of machine in the exemplary form of the computer system 300 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g. a keyboard), a cursor control device 314 (e.g. a mouse), a disk drive unit 316, a signal generation device 318 (e.g. a speaker) and a network interface device 320.

The disk drive unit 316 includes a machine-readable medium 322 on which is stored a set of instructions (i.e., software) 324 embodying any one, or all, of the methodologies described above. The software 324 is also shown to reside, completely or at least partially, within the main memory 304 and/or within the processor 302. The software 324 may further be transmitted or received via the network interface device 320. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

1. A method to process a request for communication between a calling device and a called device, the method including:
receiving the request from the calling device at a communication processor;
establishing a communication link between the communication processor and the called device;
providing the called device with a prepayment option to pay funds into a client account;
monitoring the called device for selection of the prepayment option; and
connecting the called device to a prepayment facility when the prepayment option is selected.

2. The method of claim 1, wherein connecting the called device to the prepayment facility includes establishing a communication link to the prepayment facility without terminating the communication link between the communication processor and the called device.

3. The method of claim 1, which includes providing the called device with an option to accept or terminate the request to communicate from the calling device prior to providing the called device with the prepayment option.

4. The method of claim 1, which includes:
connecting the calling device to the called device for a predetermined duration to allow communication for the predetermined duration; and
terminating the connection between the calling device with the communication processor.

5. The method of claim 1, wherein connecting the called device to the prepayment facility includes:
establishing a communication link between the communication processor and the prepayment facility; and
bridging the communication link between the communication link between the communication processor and the called device and the communication link between the communication processor and the prepayment facility.

6. The method of claim 1, which includes:
receiving prepayment transaction data from the prepayment facility; and
adjusting the client account in response to the transaction data.

7. The method of claim 1, wherein the client account forms part of the communication processor, the client account having an account identifier entered at the calling device to establish the communication link to the called device.

8. The method of claim 1, which includes checking if a collect call can be placed to the called device prior to providing the prepayment option.

9. The method of claim 1, which includes providing the prepayment option to the called device when a collect call billing threshold has been reached.

10. The method of claim 1, which includes communicating a predetermined voice message to the called device when a collect call threshold has been reached.

11. The method of claim 1, which includes;
monitoring each time a request for communication between the calling device and the called device is made; and
communicating a predetermined voice message to the called device dependent upon a number of requests that have been made.

12. The method of claim 1, which includes:
monitoring a status of the client account; and
communicating a predetermined voice message to the called device dependent upon the status.

13. The method of claim 1, which monitors DTMF signals from the called device thereby to monitor selection of the prepayment option.

14. The method of claim 1, wherein the calling device and called device are telephones for voice communication.

15. The method of claim 1, which includes:
monitoring a balance of the client account; and
communicating a voice message to the called device dependent upon the balance of the client account.

16. A machine-readable medium which embodies a sequence of instructions which, when executed by the machine, cause the machine to execute the method of claim 1.

17. A communication processing system to process a request for communication between a calling device and a called device, the system including:
a communication module to receive the request from the calling device and to establish a communication link between the communication module and the called device;
a prepayment module to provide the called device with a prepayment option to pay funds into a client account; and
monitoring module to monitor the called device for selection of the prepayment option, the communication module connecting the called device to a prepayment facility when the prepayment option is selected.

18. The communication processing system of claim 17, wherein connecting the called device to the prepayment facility includes establishing a communication link to the prepayment facility without terminating the communication link between the communication processor and the called device.

19. The communication processing system of claim 17, which provides the called device with an option to accept or terminate the request to communicate from the calling device prior to providing the called device with the prepayment option.

20. The communication processing system of claim 17, which connects the calling device to the called device for a predetermined duration to allow communication for the predetermined duration, and terminates the connection between the calling device with the communication module.

21. The communication processing system of claim 17, which connects the called device to the prepayment facility by establishing a communication link between the communication module and the prepayment facility, and bridges the communication link between the communication link between the communication module and the called device and the communication link between the communication module and the prepayment facility.

22. The communication processing system of claim 17, which adjusts the client account in response to the transaction data received from the prepayment facility.

23. The communication processing system of claim 17, wherein the client account forms part of the prepayment module, the client account having an account identifier entered at the calling device to establish the communication link to the called device.

24. The communication processing system of claim 17, which checks if a collect call can be placed to the called device prior to providing the prepayment option.

25. The communication processing system of claim 17, which provides the prepayment option to the called device when a collect call billing threshold has been reached.

26. The communication processing system of claim 17, which communicates a predetermined voice message to the called device when a collect call threshold has been reached.

27. The communication processing system of claim 17, which monitors each time a request for communication between the calling device and the called device is made and communicates a predetermined voice message to the called device dependent upon a number of requests that have been made.

28. The communication processing system of claim 17, which monitors a status of the client account, and communicates a predetermined voice message to the called device dependent upon the status.

29. The communication processing system of claim 17, which monitors DTMF signals from the called device thereby to monitor selection of the prepayment option.

30. The communication processing system of claim 17, wherein the calling device and called device are telephones for voice communication.

31. The communication processing system of claim 17, which monitors a balance of the client account and communicates a voice message to the called device dependent upon the balance of the client account.

32. A communication processing system to process a request for communication between a calling device and a called device, the system including:
means to receive the request from the calling device and to establish a communication link between a communication module and the called device;
means to provide the called device with a prepayment option to pay funds into a client account; and
means to monitor the called device for selection of the prepayment option, the communication module connecting the called device to a prepayment facility when the prepayment option is selected.
